(19) United States
(12) Patent Application Publication
(10) Pub. No.: US 2005/0257645 A1
(43) Pub. Date: Nov. 24, 2005

(54) In-flight thermal control of droplets

(75) Inventors: Robert F. Smith, Costa Mesa, CA (US); Brian M. Michaelis, Loma Linda, CA (US); Melissa E. Orme-Marmarelis, Irvine, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: THE REGENTS OF THE UNIVERSITY OF CALIFORNIA

(21) Appl. No.: 10/986,683

(22) Filed: Nov. 12, 2004

Related U.S. Application Data
(60) Provisional application No. 60/520,517, filed on Nov. 14, 2003.

(51) Int. Cl. F03B 1/00

(52) U.S. Cl. 75/331

(57) ABSTRACT

A temperature control device and methods that facilitate highly efficient thermal control of in-flight material. The temperature control device includes a two piece disc shaped body formed of an insulating material with a stepped second axial passage extending there through. A diffuser is mounted within a stepped portion of the axial passage in spaced relation with a lateral wall of the passage. A heat exchanger extends about the exterior of the diffuser between the diffuser and the lateral wall. In operation, gas flows from a gas flow passageway into the space between the diffuser and the lateral wall, and then diffuses into an interior space of the diffuser as material, such as a droplet stream, passes through the passage and cooled or heated accordingly. The temperature of droplets passing through the passage can be precisely altered up to about 90° F. in 10 ms (milliseconds).

### CROSS-REFERENCE TO RELATED APPLICATIONS

This application claims the benefit of U.S. provisional application Ser. No. 60/520,517, filed Nov. 14, 2003, which is fully incorporated herein by reference.

This invention was made with Government support under Grant No. DMI-0070053, awarded by NSF. The Government has certain rights in this invention.

### FIELD OF INVENTION

The invention relates to methods and apparatus for the control of the temperature (heat or cool) of in-flight or moving material such as the heating or cooling of a stream of droplets.

### BACKGROUND

The generation of droplets from capillary stream break-up has been studied at least as early as Lord Rayleigh in the 1800s. More recently, the formation of metallic droplets from the break-up of a molten metal capillary stream has been used in precision droplet manufacturing (“PDM”). Using the process of capillary stream break-up, droplets can be produced at very high rates—typically tens of thousands of droplets per second. In PDM, droplets are typically on the order of 200 μm in diameter and traveling at 5 m/s. Such processes are commonly used today in the electronics industry for various applications, including the formation of interconnects for small electronics packages and in the manufacture of conductive pastes.

Proper thermal control of in-flight droplets has been shown to facilitate more precise manufacturing. Thus, apparatus and methods for improved thermal control of in flight droplets or material are desirable.

### SUMMARY

The present invention is directed to an apparatus and methods that facilitate highly efficient thermal control of in-flight or moving material. Thermal control of in-flight or moving material is accomplished with the use of a heat exchanger and a heat transfer media (gas or liquid) with favorable thermal characteristics to control the temperature of the material. Forced convection is the dominate hear transfer mechanism of the method and apparatus of the present invention.

In a preferred embodiment, the temperature control device of the present invention includes a two piece disc shaped body formed of an insulating material. A top disc has a relatively narrow first axial passage extending there through. The first axial passage is coupled to a larger stepped second axial passage extending through a bottom disc. A diffuser is mounted within the second axial passage above a stepped portion and in spaced relation with a lateral wall of the second passage. A heat exchanger extends about the exterior of the diffuser between the diffuser and the lateral wall of the passage. A gas flow passageway is positioned in and is in communication with the space between the diffuser and the lateral wall of the second axial passage. In operation, gas flows from the gas flow passageway into the space between the diffuser and the lateral wall, and then diffuses into an interior space of the diffuser as material, such as a droplet stream, passes through the axial passages. As the droplets pass through the axial passages, the droplets are cooled or heated accordingly.

Large temperature changes can be realized extremely fast even though the thermal control device of the present invention is very compact. The thermal control device of the present invention has been shown to precisely alter the temperature of droplets passing through the axial passages up to about 90° F. in 10 ms (milliseconds).

Other features and advantages of the invention will be or will become apparent to one with skill in the art upon examination of the following figures and detailed description.

### BRIEF DESCRIPTION OF DRAWINGS

FIG. 1 is a perspective view of a thermal control device of the present invention.

### DETAILED DESCRIPTION OF PREFERRED EMBODIMENT

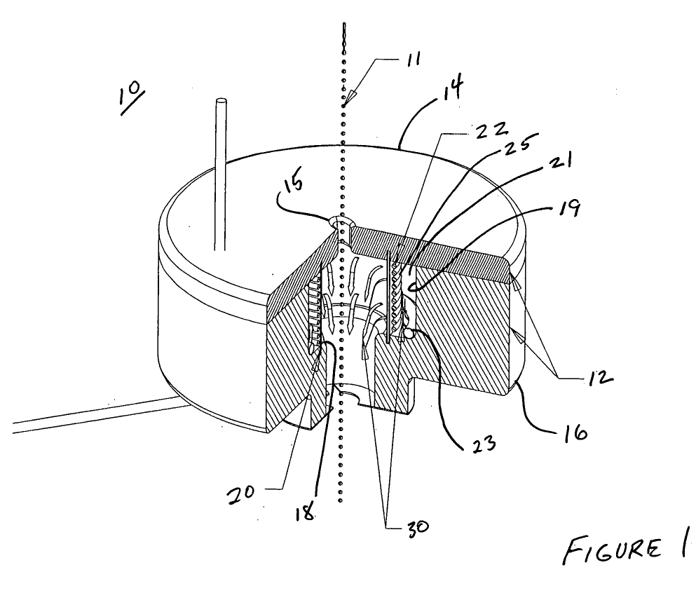

As depicted in FIG. 1, an embodiment of the in flight temperature control device 10 comprises a two piece—top and bottom portion—disc shaped body 12 formed of an insulating material. The body 12 preferably includes a relatively thin top disc 14 or cap fixedly mounted on a generally thicker bottom disc 16. The top disc 14 has a relatively narrow first axial passage 15 extending there through and coupled to a larger stepped second axial passage 17 extending through the bottom disc 16.

A diffuser 20 is mounted within the second axial passage 17 above the stepped portion 18 and in spaced relation with the upper lateral wall 19 of the second passage 17. A heat exchanger 22 extends about and adjacent the exterior of the diffuser 20 between the diffuser 20 and the upper lateral wall 19 of the second passage 17 in the bottom disc 16. The heat exchanger 22 includes tubing 25 wound about the diffuser 20.

A gas flow passageway 23 depicted as a tube or pipe is located in the space 21 between the diffuser 20 and the upper lateral wall 19 adjacent the step 18 and upper lateral wall 19. The gas flow passageway 23 is in communication with the space 21 between the diffuser 20 and the upper lateral wall 19 of the second passageway 17. A heat transfer media such as gas or liquid with favorable thermal characteristics preferable is supplied through the gas flow passageway 23.

In operation, gas 30 or other heat transfer media flows into the space 21 between the diffuser 20 and the upper lateral wall 19 from the gas flow passageway 23. The gas 30 diffuses through the wall of the diffuser 20 into the interior space of the diffuser 20 and second passageway 17. Material, such as a droplet stream 11, which may be molten metal or other material, enters the body 12 of the temperature control device 10 through the first passageway 15 and passes through the second axial passageway 17. As the droplets 11 pass through the second axial passageway 17 through the interior space of the diffuser 20, they may be cooled or heated accordingly by the gas 30 that has diffused from the space 21 between the diffuser 20 and upper lateral wall 19 across the heat exchanger through the diffuser 20 into the interior space of the diffuser. Depending on the temperature control desired, a cooling or heating medium will pass through the tubing 25 of the heat exchanger to heat or cool the gas 30 as it passes over the heat exchanger 22 and diffuses through the diffuser 20 to the interior space of the diffuser 20.

Through use of the temperature control device 10, highly efficient temperature modification is possible where large temperature changes can be realized extremely fast even though the device 10 is compact. As a result, thermal control of a stream of molten metal droplets typically found in a process like precision droplet manufacturing (PDM) can be done effectively. In PDM, molten metal droplets, typically on the order of 200 mm in diameter, are typically traveling at a rate of about 5 m/s. The temperature control device 10 of the present invention has been shown to precisely alter the droplet temperature up to 90° F. in ten milli-seconds.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

1. A temperature control device for cooling in-flight material comprising
a disc shaped body,
a stepped axial passage extending through the body,
a diffuser mounted within the axial passage above a stepped portion and in spaced relation with an upper lateral wall of the passage, and
a heat exchanger positioned about the exterior of the diffuser between the diffuser and the upper lateral wall of the passage.

2. The device of claim 1 wherein the body comprises a top disc and a bottom disc.

3. The device of claim 1 wherein the body is formed from an insulting material.

4. The device of claim 2 wherein the axial passage comprises a first portion extending through the top disc and a second, larger portion in communication with the first portion and extending through the bottom disc.

5. The device of claim 4 wherein the second portion of the axial passage is stepped.

6. A method for controlling the temperature of in-flight material comprising the steps of
passing material through an axial passage extending through a body wherein the passage includes a diffuser and a heat exchanger, and
adjusting the temperature of the material passing through the body.

7. The method of claim 6 wherein the adjusting the temperature step comprises heating the material.

8. The method of claim 6 wherein the adjusting the temperature step comprises cooling the material.

9. The method of claim 6 wherein the passing material step includes passing molten metal droplets through the axial passage.

10. The method of claim 9 wherein the molten metal droplets are about 200 millimeters in diameter.

11. The method of claim 9 wherein the molten metal droplets are traveling at a rate of about 5 m/s.

12. The method of claim 6 wherein the adjusting step includes altering the temperature of the material by about 90° F.

13. The method of claim 6 wherein the adjusting step includes altering the temperature of the material by about 50-90° F.

14. The method of claim 11 wherein the adjusting step includes altering the temperature of the molten metal droplets by about 90° F.

15. The method of claim 11 wherein the adjusting step includes altering the temperature of the molten metal droplets by about 50-90° F.
